(19) United States
(12) Patent Application Publication
(10) Pub. No.: US 2020/0311664 A1
(43) Pub. Date: Oct. 1, 2020

(54) PERISHABLE GOOD COMPARISON SYSTEM

(71) Applicant: CARRIER CORPORATION, Palm Beach Gardens, FL (US)

(72) Inventors: Ciara Poolman, Syracuse, NY (US); Robert A. Chopko, Baldwinsville, NY (US); Marc Beasley, Beverly, MA (US); John Cronin, Bonita Springs, FL (US); Michael Glynn D?Andrea, Burlington, VT (US)

(21) Appl. No.: 16/310,947

(22) PCT Filed: Jun. 16, 2017
(86) PCT No.: PCT/US2017/037909

§ 371 Date: Dec. 18, 2018

Related U.S. Application Data
(60) Provisional application No. 62/352,405, filed on Jun. 20, 2016.

(51) Int. Cl. G06Q 10/08; G06Q 50/28

(52) U.S. Cl. CPC G06Q 10/0832; G06Q 10/0838; G06Q 50/28

(57) ABSTRACT

A system for comparing perishable goods including: a storage device (80) to store consumer parameters (84) and historical quality parameters (82) associated with the perishable goods; and a quality management system (90) coupled to the storage device. The quality management system including; a current quality module (92) to determine current quality parameters (101) of the perishable goods in response to the historical quality parameters; a quality projection module (94) to determine predicted quality parameters (102) of the perishable goods in response to the historical quality parameters and the consumer parameters; a cost analysis module (96) to determine cost parameters (103) in response to at least one of the historical quality parameters, the consumer parameters, the current quality parameters, and the predicted quality parameters; and a comparison module (98) to determine output parameters (100) in response to at least one of the historical quality parameters, the consumer parameters, the current quality parameters, the predicted quality parameters, and the cost parameters.

### BACKGROUND OF THE DISCLOSURE

The embodiments disclosed herein generally relate to cold chain distribution systems, and more specifically to an apparatus and a method for monitoring and comparing perishable goods.

Typically, cold chain distribution systems are used to transport and distribute perishable goods and environmentally sensitive goods (herein referred to as perishable goods) that may be susceptible to temperature, humidity, and other environmental factors. Perishable goods may include but are not limited to fruits, vegetables, grains, beans, nuts, eggs, dairy, seed, flowers, meat, poultry, fish, ice, and pharmaceuticals. Advantageously, cold chain distribution systems allow perishable goods to be effectively transported and distributed without damage or other undesirable effects.

Refrigerated trucks and trailers are commonly used to transport perishable goods in a cold chain distribution system. A transport refrigeration system is mounted to the truck or to the trailer in operative association with a cargo space defined within the truck or trailer for maintaining a controlled temperature environment within the cargo space.

Conventionally, transport refrigeration systems used in connection with refrigerated trucks and refrigerated trailers include a transport refrigeration unit having a refrigerant compressor, a condenser with one or more associated condenser fans, an expansion device, and an evaporator with one or more associated evaporator fans, which are connected via appropriate refrigerant lines in a closed refrigerant flow circuit. Air or an air/ gas mixture is drawn from the interior volume of the cargo space by means of the evaporator fan(s) associated with the evaporator, passed through the airside of the evaporator in heat exchange relationship with refrigerant whereby the refrigerant absorbs heat from the air, thereby cooling the air. The cooled air is then supplied back to the cargo space.

Consumers are becoming increasingly concerned with the quality and price of the perishable goods they are purchasing. It is often difficult to predict the quality of perishable goods as the perishable goods may change hands several times along the route. Thus, making it difficult for consumers to gage quality at the time of purchase. Quality is closely linked to price and consumers are typically willing to pay more to get higher quality perishable goods while simultaneously desiring a discount on lower quality perishable goods. Improved systems, particularly improved systems for comparing perishable goods would provide benefits to the industry.

### BRIEF DESCRIPTION OF THE DISCLOSURE

According to one embodiment, a system for comparing perishable goods is provided. The system including: a storage device to store consumer parameters and historical quality parameters associated with the perishable goods; and a quality management system coupled to the storage device. The quality management system including; a current quality module to determine current quality parameters of the perishable goods in response to the historical quality parameters; a quality projection module to determine predicted quality parameters of the perishable goods in response to the historical quality parameters and the consumer parameters; a cost analysis module to determine cost parameters in response to at least one of the historical quality parameters, the consumer parameters, the current quality parameters, and the predicted quality parameters; and a comparison module to determine output parameters in response to at least one of the historical quality parameters, the consumer parameters, the current quality parameters, the predicted quality parameters, and the cost parameters.

In addition to one or more of the features described above, or as an alternative, further embodiments of the system may include a user device configured to transmit the consumer parameters to the storage device and receive output parameters from the quality management system.

In addition to one or more of the features described above, or as an alternative, further embodiments of the system may include that the user device transmits the consumer parameters through at least one of passive transmission, active transmission, and automatic transmission.

In addition to one or more of the features described above, or as an alternative, further embodiments of the system may include that the output parameters are configured as at least one of a map displaying time-based locations of the perishable goods along with the output parameters at the time-based locations, a data table of output parameters, and a quality versus time graph.

In addition to one or more of the features described above, or as an alternative, further embodiments of the system may include a user device activates an alarm when the perishable goods are within at least one of a selected quality range, a selected price range, and a geographical area.

In addition to one or more of the features described above, or as an alternative, further embodiments of the system may include at least one sensor configured to monitor the historical quality parameters of the perishable goods and transmit the historical quality parameters to the storage device.

In addition to one or more of the features described above, or as an alternative, further embodiments of the system may include that the output parameters include at least one of a cost comparison and a quality comparison.

According to another embodiment, a method of comparing perishable goods is provided. The method including: storing, using a storage device, consumer parameters and historical quality parameters associated with the perishable goods; and analyzing, using a quality management system, the historical quality parameters and the consumer parameters. The quality management system coupled to the storage device. The quality management system including: a current quality module to determine current quality parameters of the perishable goods in response to the historical quality parameters; a quality projection module to determine predicted quality parameters of the perishable goods in response to the historical quality parameters and the consumer parameters; a cost analysis module to determine cost parameters in response to at least one of the historical quality parameters, the consumer parameters, the current quality parameters, and the predicted quality parameters; and a comparison module to determine output parameters in response to at least one of the historical quality parameters, the consumer parameters, the current quality parameters, the predicted quality parameters, and the cost parameters.

In addition to one or more of the features described above, or as an alternative, further embodiments of the method may include transmitting, using a user device, consumer parameters to the storage device.

In addition to one or more of the features described above, or as an alternative, further embodiments of the method may include receiving, using a user device, output parameters from the quality management system.

In addition to one or more of the features described above, or as an alternative, further embodiments of the method may include that the user device transmits the consumer parameters through at least one of passive transmission, active transmission, and automatic transmission.

In addition to one or more of the features described above, or as an alternative, further embodiments of the method may include that the output parameters are configured as at least one of a map displaying time-based locations of the perishable goods along with the output parameters at the time-based locations, a data table of output parameters, and a quality versus time graph.

In addition to one or more of the features described above, or as an alternative, further embodiments of the method may include activating, using a user device, an alarm when the perishable goods are within at least one of a selected quality range, a selected price range, and a geographical area.

In addition to one or more of the features described above, or as an alternative, further embodiments of the method may include: monitoring, using at least one sensor, the historical quality parameters of the perishable goods; and transmitting the historical quality parameters to the storage device.

In addition to one or more of the features described above, or as an alternative, further embodiments of the method may include that the output parameters include at least one of a cost comparison and a quality comparison.

According to another embodiment, a computer program product tangibly embodied on a computer readable medium is provided. The computer program product including instructions that, when executed by a processor, cause the processor to perform operations. The operations including: storing, using a storage device, consumer parameters and historical quality parameters associated with the perishable goods; and analyzing, using a quality management system, the historical quality parameters and the consumer parameters. The quality management system coupled to the storage device. The quality management system including: a current quality module to determine current quality parameters of the perishable goods in response to the historical quality parameters; a quality projection module to determine predicted quality parameters of the perishable goods in response to the historical quality parameters and the consumer parameters; a cost analysis module to determine cost parameters in response to at least one of the historical quality parameters, the consumer parameters, the current quality parameters, and the predicted quality parameters; and a comparison module to determine output parameters in response to at least one of the historical quality parameters, the consumer parameters, the current quality parameters, the predicted quality parameters, and the cost parameters.

In addition to one or more of the features described above, or as an alternative, further embodiments of the computer program may include that the operations further include transmitting, using a user device, consumer parameters to the storage device.

In addition to one or more of the features described above, or as an alternative, further embodiments of the computer program may include that the operations further include receiving, using a user device, output parameters from the quality management system.

In addition to one or more of the features described above, or as an alternative, further embodiments of the computer program may include that the user device transmits the consumer parameters through at least one of passive transmission, active transmission, and automatic transmission.

In addition to one or more of the features described above, or as an alternative, further embodiments of the computer program may include that the output parameters are configured as at least one of a map displaying time-based locations of the perishable goods along with the output parameters at the time-based locations, a data table of output parameters, and a quality versus time graph.

In addition to one or more of the features described above, or as an alternative, further embodiments of the computer program may include that the operations further include activating, using a user device, an alarm when the perishable goods are within at least one of a selected quality range, a selected price range, and a geographical area.

In addition to one or more of the features described above, or as an alternative, further embodiments of the computer program may include that the operations further include: monitoring, using at least one sensor, the historical quality parameters of the perishable goods; and transmitting the historical quality parameters to the storage device.

In addition to one or more of the features described above, or as an alternative, further embodiments of the computer program may include that the output parameters include at least one of a cost comparison and a quality comparison.

Technical effects of embodiments of the present disclosure include tracking various quality parameters of perishable goods, using the quality parameters to predict a quality level of the perishable goods, and pricing the perishable goods response to the quality level. Further technical effects of embodiments of the present disclosure include comparing the cost and the quality of perishable goods within a selected geolocation.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter which is regarded as the disclosure is particularly pointed out and distinctly claimed in the claims at the conclusion of the specification. The foregoing and other features and advantages of the disclosure are apparent from the following detailed description taken in conjunction with the accompanying drawings in which:

FIG. 1 illustrates a schematic view of a system for comparing perishable goods, according to an embodiment of the present disclosure;

FIG. 2 illustrates a schematic view a cold chain distribution system that may incorporate embodiments of the present disclosure; and

FIG. 3 is a flow diagram illustrating a method of comparing perishable goods, according to an embodiment of the present disclosure.

### DETAILED DESCRIPTION OF THE DISCLOSURE

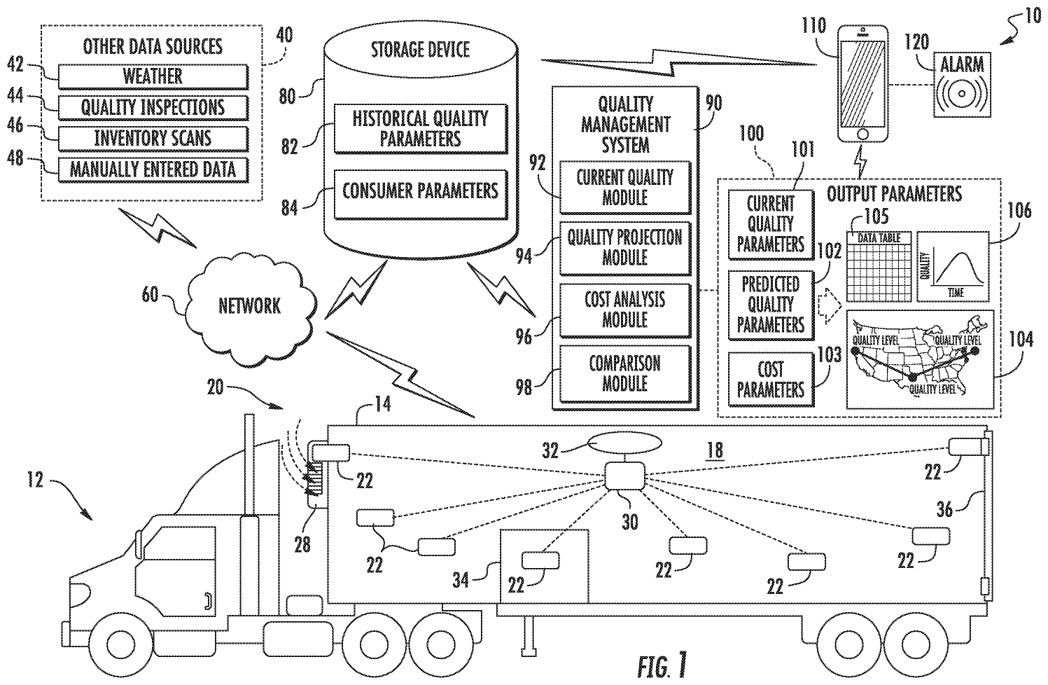

Referring now to the drawings, FIG. 1 illustrates a schematic view of a system 10 for comparing perishable goods, according to an embodiment of the present disclosure. FIG. 2 illustrates a schematic view a cold chain distribution system 200 that may incorporate embodiments of the present disclosure. Typically, transport refrigeration systems 20 are used to transport and distribute perishable goods and environmentally sensitive goods (herein referred to as perishable goods 34). In the illustrated embodiment, a transport refrigeration system 20 includes an environmentally controlled container 14, a transport refrigeration unit 28 and perishable goods 34. The container 14 may be pulled by a tractor 12. It is understood that embodiments described herein may be applied to shipping containers that are shipped by rail, sea, or any other suitable container, without use of a tractor 12. The container 14 may define an interior compartment 18.

In the illustrated embodiment, the transport refrigeration unit 28 is associated with a container 14 to provide desired environmental parameters, such as, for example temperature, pressure, humidity, carbon dioxide, ethylene, ozone, light exposure, vibration exposure, and other conditions to the interior compartment 18. In further embodiments, the transport refrigeration unit 28 is a refrigeration system capable of providing a desired temperature and humidity range. The perishable goods 34 may include but are not limited to fruits, vegetables, grains, beans, nuts, eggs, dairy, seed, flowers, meat, poultry, fish, ice, blood, pharmaceuticals, or any other suitable cargo requiring cold chain transport.

In the illustrated embodiment, the transport refrigeration system 20 includes sensors 22, which may be hard wired or wireless. The sensors 22 may be utilized to monitor historical quality parameters 82 of the perishable goods 34. The historical quality parameters 82 monitored by the sensors 22 may include but are not limited to temperature, pressure, humidity, carbon dioxide, ethylene, ozone, light exposure, vibrations, and other conditions in the interior compartment 18. Accordingly, suitable sensors 22 are utilized to monitor the desired historical quality parameters 82. Advantageously, sensors 22 may be selected for certain applications depending on the type of perishable goods 34 to be monitored and the corresponding environmental sensitivities. In an embodiment, temperatures are monitored. As seen in FIG. 1, the sensors 22 may be placed directly on the perishable goods 34.

The sensors 22 may be placed in a variety of locations including but not limited to on the transport refrigeration unit 28, on a door 36 of the container 14 and throughout the interior compartment 18. The sensors 22 may be placed directly within the transport refrigeration unit 28 to monitor the performance of the transport refrigeration unit 28. As seen, the sensors 22 may also be placed on the door 36 of the container 14 to monitor the position of the door 36. Whether the door 36 is open or closed affects both the temperature of the container 14 and the perishable goods 34. For instance, in hot weather, an open door 36 will allow cooled air to escape from the container 14, causing the temperature of the interior compartment 18 to rise, thus affecting the temperature of the perishable goods 34. Additionally, a global positioning system (GPS) location may also be detected by the sensors 22. The GPS location may help in providing time-based location information for the perishable goods 34 that will help in tracking the travel route and other historical quality parameters 82 along that route. For instance, the GPS location may also help in providing information from other data sources 40 regarding weather 42 experienced by the container 14 along the travel route. The local weather 42 affects the temperature of the container 14 and thus may affect the temperature of the perishable goods 34.

As illustrated in FIG. 1, the transport refrigeration system 20 may further include, a controller 30 configured to log a plurality of readings from the sensors 22, known as the historical quality parameters 82, at a selected sampling rate. The controller 30 may be enclosed within the transport refrigeration unit 28 or separate from the transport refrigeration unit 28 as illustrated. The historical quality parameters 82 may further be augmented with time, location stamps or other relevant information. The controller 30 may also include a processor (not shown) and an associated memory (not shown). The memory may be a storage device 80, as seen in FIG. 1. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium.

In an illustrated embodiment, the transport refrigeration system 20 may include a communication module 32 in operative communication with the controller 30 and in wireless operative communication with a network 60. The communication module 32 is configured to transmit the historical quality parameters 82 to the network 60 via wireless communication. The wireless communication may be, but is not limited to, radio, microwave, cellular, satellite, or another wireless communication method. The network 60 may be but is not limited to satellite networks, cellular networks, cloud computing network, wide area network, or another type of wireless network. The communication module 32 may include a short range interface, wherein the short range interface includes at least one of: a wired interface, an optical interface, and a short range wireless interface.

Historical quality parameters 82 may also be provided by other data sources 40, as illustrated in FIG.1. These other data sources 40 may be collected at any point throughout the cold chain distribution system 200, which as illustrated in FIG. 2 may include harvest 204, packing 206, storage prior to transport 208, transport to distribution center 210, distribution center 212, transport to display 214, storage prior to display 216, display 218 and consumer 220. These stages are provided for illustrative purposes and a distribution chain may include fewer stages or additional stages, such as, for example a cleaning stage, a processing stage, and additional transportation stages. The other data sources 40 may include, but are not limited to, weather 42, quality inspections 44, inventory scans 46, and manually entered data 48. The weather 42, as discussed above, has an effect on the operation of the transport refrigeration unit 28 by influencing the temperature of the container 14 during transport (e.g., 210 and 214) but the weather 42 also has other influences on the transport refrigeration unit 28. For instance, the weather 42 prior to and at harvest 204 may have an impact on the quality of the perishable goods 34, which may affect quality. Moreover, quality inspections 44, similar to the weather 42, may reveal data of the perishable goods 34 that affects quality. For instance, a particular batch of strawberries may have been subjected to rainfall at harvest 200, making them prone to spoilage. Quality inspections 44 may be done by a machine or a human being. Quality inspections 44 performed by a machine may be accomplished using a variety of techniques including but not limited to optical, odor, soundwave, infrared, or physical probe.

Further, inventory scans 46 may also reveal historical quality parameters 82 about the perishable goods 34 and may help in tracking the perishable goods 34. For instance, the inventory scan 46 may reveal the time, day, truck the perishable goods arrived on, which may help identify the farm if previously unknown. While the system 10 includes sensors 22 to aid in automation, often times the need for manual data entry is unavoidable. The manually entered data 48 may be input via a variety of devices including but not limited to a cellular phone, tablet, laptop, smartwatch, a desktop computer or any other similar data input device known to one of skill in the art.

Historical quality parameters 82 collected throughout each stage of the cold chain distribution system 200 may include environment conditions experienced by the perishable goods 34 such as, for example, temperature, pressure, humidity, carbon dioxide, ethylene, ozone, vibrations, light exposure, weather, time and location. For instance, strawberries may have experienced an excessive shock or were kept at 34° F. during transport. Historical quality parameters 82 may further include attributes of the perishable goods 34 such as, for example, temperature, weight, size, sugar content, maturity, grade, ripeness, labeling, and packaging. For instance, strawberries may be packaged in 1 pound clamshells, be a certain weight or grade, be organic, and have certain packaging or labels on the clamshells. Historical quality parameters 82 may also include information regarding the operation of the environmental control unit 28, as discussed above. The historical quality parameters 82 may further be augmented with time, location stamps or other relevant information.

In the illustrated embodiment, the system 10 further includes a storage device 80 to store the historical quality parameters 82 associated with the perishable goods 34 of a distribution chain. At least one of the historical quality parameters 82 may be received from a transport refrigeration system. The storage device 80 is connected to the communication module 32 through the network 60. As shown, the storage device 80 also stores consumer parameters 84, which are described further below. The storage device 80 may be but is not limited to a random access memory (RAM), read only memory (ROM), or other electronic, optical, magnetic or any other computer readable medium.

In the illustrated embodiment, the system 10 further includes a quality management system 90. The quality management system 90 is connected to the communication module 32 through the network 60. The quality management system 90 is also coupled to the storage device 80. As shown, the quality management system 90 includes a current quality module 92, a quality projection module 94, a cost analysis module 96, and a comparison module 98. The quality management system 90 may also include a processor (not shown) and an associated memory (not shown). The associated memory may be the storage device 80. The processor may be but is not limited to a single-processor or multi-processor system of any of a wide array of possible architectures, including field programmable gate array (FPGA), central processing unit (CPU), application specific integrated circuits (ASIC), digital signal processor (DSP) or graphics processing unit (GPU) hardware arranged homogenously or heterogeneously. The memory may be but is not limited to a random access memory (RAM), read only memory (ROM), or other electronic, optical, magnetic or any other computer readable medium. The current quality module 92, the quality projection module 94, the cost analysis module 96, and the comparison module 98 may be implemented in software as applications executed by the processor of quality management system 90.

The current quality module 92 determines current quality parameters 101 of the perishable goods 34 in response to the historical quality parameters 82. The quality projection module 94 determines predicted quality parameters 102 of the perishable goods 34 in response to the historical quality parameters 82 and the consumer parameters 84. Consumer parameters 84 may include information regarding: the geolocation of the consumer at the time of purchasing the perishable goods 34, the time when the perishable goods 34 were purchased, the type of perishable goods 34 (ex: bananas), the brand of perishable goods 34, how the perishable goods 34 will be stored, when the perishable goods 34 will be consumed, how much the consumer desires to pay for the perishable goods 34 (selected price range), and the quality of perishable goods 34 desired by the consumer (selected quality range). Some of the consumer parameters 84 may be collected passively (i.e. passive transmission) by the user device 110 such as, for example, tracking the time and location of the consumer at the time the perishable goods 34 were purchased. The user device 110 may be a device such as, for example, a cellular phone, tablet, laptop, smartwatch, desktop computer, kiosk or any similar device. For instance, a kiosk may be located at a farmers' market, allowing consumers to conduct research using the quality management system 90 right at the farmers' market. In another example, the consumer may use their smart phone to conduct research using the quality management system 90. Further, some consumer parameters may be collected automatically (i.e. automatic transmission) when the consumer scans an ID tag of the perishable goods 34 with their user device 110, such as, for example the type of perishable goods 34 and the brand of perishable goods 34. The ID tag may be a Universal Product Code (UPC) bar code, Quick Response (QR) code, or another identification methodology known to one of skill in the art. Some consumer parameters 84 may have to be actively entered (i.e. active transmission) into a user device 110 such as, for example the type of perishable goods 34, the brand of perishable goods 34, how the perishable goods 34 will be stored, when the perishable goods 34 will be consumed, selected price range, and selected quality range. The type of perishable goods 34 may need to be entered into the user device 110 if an ID is unavailable to scan, such as, for example at a farmers' market where some perishable goods may not be labeled.

The cost analysis module 96 determines cost parameters 103 in response to at least one of the historical quality parameters 82, the consumer parameters 84, the current quality parameters 101, and the predicted quality parameters 102. The cost parameters 103 may include a price for the perishable goods 34 that may increase and/or decrease based on the historical quality parameters 82, the consumer parameters 84, the current quality parameters 101, and/or the predicted quality parameters 102. In one example, a poor quality perishable good 34 may be cheaper than a high quality perishable good 34. In another example, one brand of perishable good 34 might demand a higher price than other brands of perishable goods 34.

The comparison module 98 determines output parameters 100 in response to at least one of the historical quality parameters 82, the consumer parameters 84, the current quality parameters 101, the predicted quality parameters 102, and the cost parameters 103. In an embodiment, the output parameters 100 may include the quality of the perishable goods 34 at a particular time and location. The output parameters 100 may display a quality comparison of the same perishable good 34 at several different stores giving the consumer a variety of options. In another embodiment, the output parameters 100 may include the cost of the perishable goods 34 at a particular time and location. The output parameters 100 may display a cost comparison of the same perishable good 34 at several different stores giving the consumer a variety of options. Advantageously, cost comparisons and quality comparisons in the output parameters may allow the consumer to make a more informed decision prior to purchasing a perishable good. Further advantageously, a consumer might be able to find a cheaper perishable good of the same quality at a different store using a quality management system.

The output parameters 100 may be accessible via the user device 110 and/or sent directly to the user device 110. The output parameters 100 may be configured as at least one of a map 104 displaying time-based locations of the perishable goods 34 along with the output parameters 100 at the time-based locations, a data table 105 of output parameters 100, a quality versus time graph 106, a text write-up (not shown), the raw data parameters 101, 102, 103, and/or any other method of displaying output parameters known to one of skill in the art. The consumer may be able to enter in some information into their user device 110 and/or scan the ID tag of the perishable good 34 and immediately have access to output parameters 100 that could help them make an educated purchasing decision based on cost and/or quality. For instance, the consumer may be able to see the route the perishable goods 34 had taken from farm-to-fork and the quality of the perishable goods 34 throughout that route. In the event that a particular perishable good might not satisfy consumer quality requirements and or cost requirements, the quality management system 90 may be able to suggest an alternative perishable good through the user device 110 that might satisfy the consumer requirements. In an example, if one brand of tomatoes might not be ripe enough for a consumer to cook tonight, the quality management system 90 may suggest another brand of tomatoes that might be ripe to cook tonight (selected quality range). In another example, if one brand of tomatoes is too expensive, the quality management system 90 may be able to suggest another brand of tomatoes that might be in the consumer's selected price range. Further, the quality management system 90 may be able to send a notice through the user device 110 via an alarm 120 indicating that a perishable good is available at a local store in at least one of their selected price range, selected quality range, and geographical area. For instance, a consumer may like post-ripened brown bananas and their user device 110 may activate the alarm 120 indicating that post-ripened brown banana are now half-off at the grocery store on Main Street. Advantageously, a quality management system may be able to help grocery stores sell perishable goods that are past their prime ripeness but are still edible via sales sent directly to user devices. Also advantageously, a quality management system may be able to also help grocery stores compete with farmer's markets by showing consumers the high quality of the perishable goods in store at competitive prices.

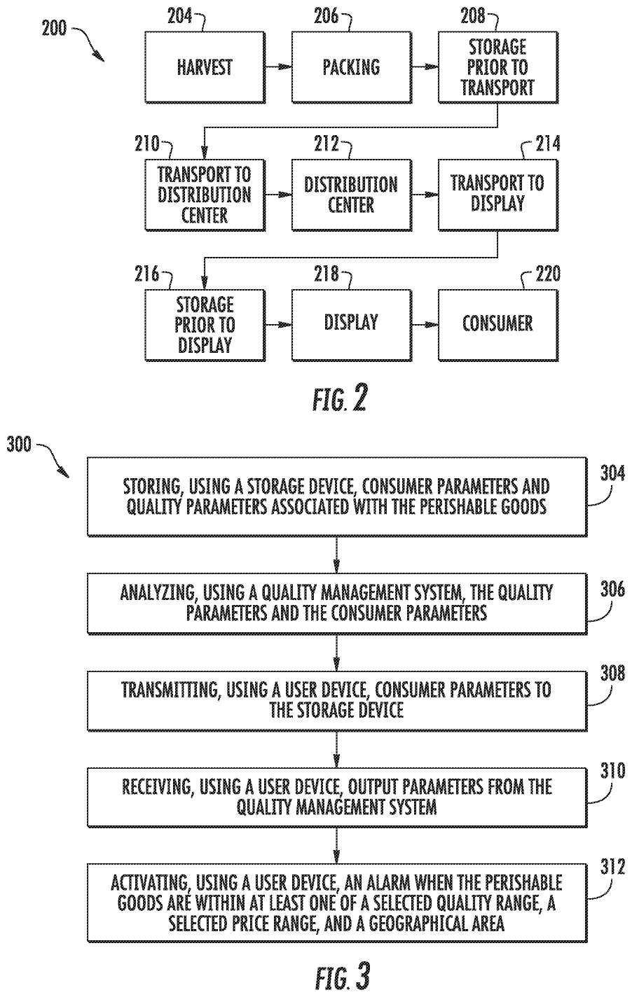

Referring now also to FIG. 3, which shows a flow diagram illustrating a method 300 of comparing perishable goods 34, according to an embodiment of the present disclosure. At block 304, the storage device 80 stores consumer parameters 84 and historical quality parameters 82 associated with the perishable goods 34. At block 306, the quality management system 90 analyses the consumer parameters 84 and historical quality parameters 82. At block 308, the user device 110 transmits the consumer parameters 84 to the storage device 80. At block 310, the user device 110 receives the output parameters 100 from the quality management system 90. As mentioned above the output parameters 100 may include at least one of a cost comparison and a quality comparison. At block 312, the user device 110 activates the alarm 120 when the perishable goods 34 are within at least one of a selected quality range, a selected price range, and a geographical area. The method 300 may also include monitoring, using at least one sensor 22, the historical quality parameters 82 of the perishable goods 34; and transmitting the historical quality parameters 82 to the storage device 80.

While the above description has described the flow process of FIG. 3 in a particular order, it should be appreciated that unless otherwise specifically required in the attached claims that the ordering of the steps may be varied.

While the disclosure has been described in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the scope of the disclosure. Additionally, while various embodiments of the disclosure have been described, it is to be understood that aspects of the disclosure may include only some of the described embodiments. Accordingly, the disclosure is not to be seen as limited by the foregoing description, but is only limited by the scope of the appended claims.

What is claimed is:

1. A system for comparing perishable goods, the system comprising:
a storage device to store consumer parameters and historical quality parameters associated with the perishable goods;
a quality management system coupled to the storage device, the quality management system including;
a current quality module to determine current quality parameters of the perishable goods in response to the historical quality parameters;
a quality projection module to determine predicted quality parameters of the perishable goods in response to the historical quality parameters and the consumer parameters;
a cost analysis module to determine cost parameters in response to at least one of the historical quality parameters, the consumer parameters, the current quality parameters, and the predicted quality parameters; and
a comparison module to determine output parameters in response to at least one of the historical quality parameters, the consumer parameters, the current quality parameters, the predicted quality parameters, and the cost parameters.

2. The system of claim 1, further comprising:
a user device configured to transmit the consumer parameters to the storage device and receive output parameters from the quality management system.

3. The system of claim 2, wherein:
the user device transmits the consumer parameters through at least one of passive transmission, active transmission, and automatic transmission.

4. The system of claim 1, wherein:
the output parameters are configured as at least one of a map displaying time-based locations of the perishable goods along with the output parameters at the time-based locations, a data table of output parameters, and a quality versus time graph.

5. The system of claim 1, further comprising:
a user device activates an alarm when the perishable goods are within at least one of a selected quality range, a selected price range, and a geographical area.

6. The system of claim 1, further comprising:
at least one sensor configured to monitor the historical quality parameters of the perishable goods and transmit the historical quality parameters to the storage device.

7. The system of claim 1, wherein:
the output parameters include at least one of a cost comparison and a quality comparison.

8. A method of comparing perishable goods, the method comprising:
storing, using a storage device, consumer parameters and historical quality parameters associated with the perishable goods;
analyzing, using a quality management system, the historical quality parameters and the consumer parameters, the quality management system coupled to the storage device, the quality management system including:
a current quality module to determine current quality parameters of the perishable goods in response to the historical quality parameters;
a quality projection module to determine predicted quality parameters of the perishable goods in response to the historical quality parameters and the consumer parameters;
a cost analysis module to determine cost parameters in response to at least one of the historical quality parameters, the consumer parameters, the current quality parameters, and the predicted quality parameters; and
a comparison module to determine output parameters in response to at least one of the historical quality parameters, the consumer parameters, the current quality parameters, the predicted quality parameters, and the cost parameters.

9. The method of claim 8, further comprising:
transmitting, using a user device, consumer parameters to the storage device.

10. The method of claim 8, further comprising:
receiving, using a user device, output parameters from the quality management system.

11. The method of claim 9, wherein:
the user device transmits the consumer parameters through at least one of passive transmission, active transmission, and automatic transmission.

12. The method of claim 8, wherein:
the output parameters are configured as at least one of a map displaying time-based locations of the perishable goods along with the output parameters at the time-based locations, a data table of output parameters, and a quality versus time graph.

13. The method of claim 8, further comprising:
activating, using a user device, an alarm when the perishable goods are within at least one of a selected quality range, a selected price range, and a geographical area.

14. The method of claim 8, further comprising:
monitoring, using at least one sensor, the historical quality parameters of the perishable goods; and
transmitting the historical quality parameters to the storage device.

15. The method claim 8, wherein:
the output parameters include at least one of a cost comparison and a quality comparison.

16. A computer program product tangibly embodied on a computer readable medium, the computer program product including instructions that, when executed by a processor, cause the processor to perform operations comprising:
storing, using a storage device, consumer parameters and historical quality parameters associated with the perishable goods;
analyzing, using a quality management system, the historical quality parameters and the consumer parameters, the quality management system coupled to the storage device, the quality management system including:
a current quality module to determine current quality parameters of the perishable goods in response to the historical quality parameters;
a quality projection module to determine predicted quality parameters of the perishable goods in response to the historical quality parameters and the consumer parameters;
a cost analysis module to determine cost parameters in response to at least one of the historical quality parameters, the consumer parameters, the current quality parameters, and the predicted quality parameters; and
a comparison module to determine output parameters in response to at least one of the historical quality parameters, the consumer parameters, the current quality parameters, the predicted quality parameters, and the cost parameters.

17. The computer program of claim 16, wherein the operations further comprise:
transmitting, using a user device, consumer parameters to the storage device.

18. The computer program of claim 16, wherein the operations further comprise:
receiving, using a user device, output parameters from the quality management system.

19. The computer program of claim 17, wherein:
the user device transmits the consumer parameters through at least one of passive transmission, active transmission, and automatic transmission.

20. The computer program of claim 16, wherein:
the output parameters are configured as at least one of a map displaying time-based locations of the perishable goods along with the output parameters at the time-based locations, a data table of output parameters, and a quality versus time graph.

21. (canceled)

22. (canceled)

23. (canceled)
